(19) United States
(12) Patent Application Publication
(10) Pub. No.: US 2007/0170661 A1
(43) Pub. Date: Jul. 26, 2007

(54) Fire ring seal

(76) Inventor: Amable Mancenido, Chicago, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/340,136

(22) Filed: Jan. 26, 2006

(51) Int. Cl. F02F 11/00

(52) U.S. Cl. 277/600

(57) ABSTRACT

A generally u-shaped fire ring is configured to receive and form a seal with a protrusion of a cylinder wall liner that extends above a surface of an engine block. The fire ring is configured to be inserted into an annular groove in a cylinder head. When the cylinder head is mounted onto the engine block, the fire ring is in the annular groove where the stepped regions of the outside surface of the fire ring forms a seal with the walls of the annular groove and the protrusion of the cylinder wall liner forms a seal with the non-stepped regions inside of the fire ring.

### BACKGROUND

The present invention relates to gaskets for internal combustion engines, and in particular, to gaskets that seal a cylinder head to an engine block around the cylinder bore.

A head gasket seals the mating surfaces of combustion chambers and various ports between the mating surfaces of a cylinder head and an engine block in an internal combustion engine. The head gasket may include a combustion ring for sealing the mating surfaces around a cylinder bore. In a conventional cylinder head gasket joint, the combustion ring is compressed by the clamping force of the bolts and the bolt bosses. The forces on the bolts are in a direction normal to the mating surfaces of the engine block and the cylinder head. The reaction forces between the bolts and bolt boss locations cause some cylinder head bending and cylinder bore distortion resulting in non-uniform stress distribution. During engine operation, there are continuing compressive mechanical forces in the immediate region of the upper portion of the cylinder bore that add to the overall distortion of the components. Combining thermal stresses of operation to the cylinder head and upper cylinder wall with the existing distortions may lead to fatigue and premature failure of the gasket material in the localized region of the upper cylinder. The continual stresses lead to micro-movement that lifts the cylinder head away from the gasket material and may eventually cause the gasket seal to fail catastrophically.

In engines that require high combustion pressures for high power output, the head gasket requires high contact sealing pressures to avoid failure. These increased contact pressures require high joint bending stiffness that is generally provided by thick wall engine design. The use of thick wall engine designs increases vehicle weight which is contrary to the trend of engine design, which includes light-weight thin wall aluminum designs of the engine. Various gasket materials and sealing arrangements for these critical areas have been developed and are known in the art. However, none of the arrangements address the contact sealing pressure that is counteracted by the increased compression lift that separates the cylinder head from the engine block.

### SUMMARY

Accordingly, improved seals and sealing materials that provide a constant and consistent seal around the combustion chamber of an internal combustion engine are desirable, and particularly, a fire ring that provides sealing forces in a direction that is perpendicular to the combustion lifting direction and that is relatively unaffected by the compressive forces would be desirable.

In one embodiment, a fire seal, also known as a fire ring, has a first wall and a second wall that is spaced from the first wall, a base connecting the first wall and the second wall, the base having a defined length, the base, the first wall and the second wall also defining a generally U-shaped opening. Stepped regions are formed in the first wall and second wall such that a distance between the stepped regions of the first wall and the second wall is equal to or greater than the length of the base. The fire ring may form a seal between a protrusion of a cylinder wall liner that fits within the opening of the U-shaped groove and the non-stepped regions of the fire ring. The fire ring fits within a groove in a cylinder head and forms a seal against the cylinder head with the stepped regions of the fire ring walls. When the fire ring is installed in this manner, the sealing forces created by the fire ring are in a direction that is perpendicular to the compressive loading forces of the bolts and combustion lift.

Other aspects of the invention will become apparent by consideration of the detailed description and accompanying drawings.

### BRIEF DESCRIPTION OF THE DRAWINGS

FIG. 1 is an exploded view of a sealing joint using a fire ring.

FIG. 2 is an exploded view of an internal combustion engine.

FIG. 3 is a close-up exploded view of the internal combustion engine.

FIG. 4 is an exemplary arrangement for a fire ring on a protrusion of a cylinder wall liner.

FIG. 5A is an exemplary view of a placement of the fire ring between a protrusion of the cylinder wall liner and an annular groove in a cylinder head.

FIG. 5B is an exemplary view of a fire ring with a stepped region on one wall.

FIG. 5C is an exemplary view of a fire ring with a stepped region on a wall closest to a cylinder bore.

FIG. 6A is an exemplary view of a prior art sealing surface of a conventional head gasket without compression or firing cycles.

FIG. 6B is a view of the prior art sealing surface of a conventional head gasket with combustion lift.

### DETAILED DESCRIPTION

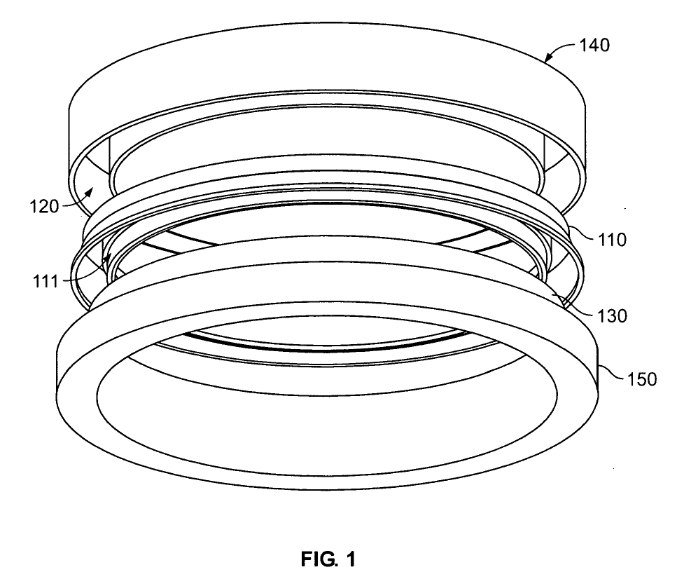

FIG. 1 illustrates two mating parts 140, 150 that may use a fire ring 110 between them as a seal. The fire ring 110 fits into an annular groove 120 extending up from a bottom surface for the first part 140. An extension or protrusion 130 extending up from the mating second part 150 is inserted into a groove 111 within the fire ring 110. Although the parts 140, 150 are illustrated as circular in FIG. 1, it is not necessary that they be circular, but the corresponding parts should accommodate a seal.

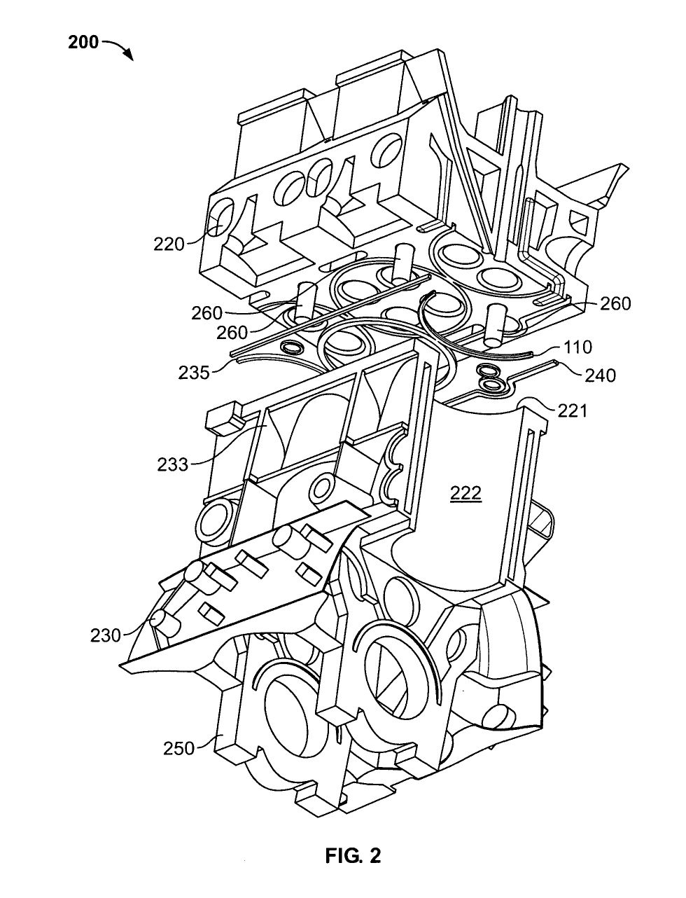

FIG. 2 illustrates an exemplary embodiment for a fire ring 110 in a partial cutaway view of an internal combustion engine 200. A cylinder head 220 may be mounted on a cylinder block 230. The bolts 260 may be torqued to firmly attach the cylinder head 220 to the engine block 230 and compress a head gasket 240 that provides a seal for the oil feed lines or ports (not shown), the water jacket 233, and the push rod channels (not shown) that communicate and are continuous between the cylinder head 220 and the engine block 230. In some embodiments of the internal combustion engine 200, oil may return from the top of the cylinder head 220 through the pushrod channels or other return channels (not shown), dripping back into the crankcase area 250. The coolant may surround the cylinder bores 221 and a portion of the cylinder head 220. The head gasket 240 will seal the ports and the water jacketed areas, isolating the fluids from one another to avoid cross-contamination. The fire ring 110 seals the top surfaces of the area surrounding the cylinder bore 221 and the cylinder head 220. In a preferred embodiment, the fire ring 110 is a separate component, but is installed simultaneously with the head gasket 240. In other aspects, the fire ring 110 may be integral to the head gasket 240.

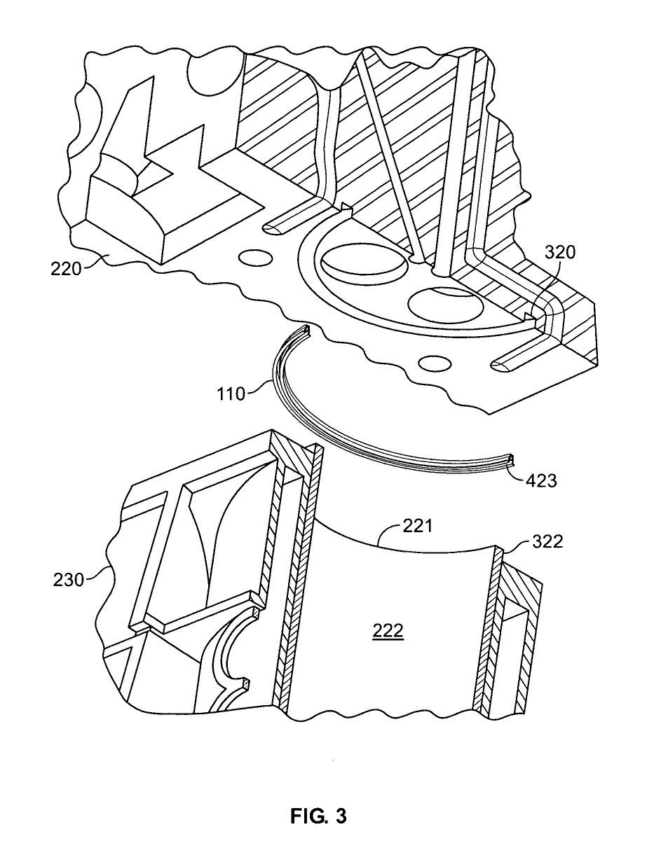

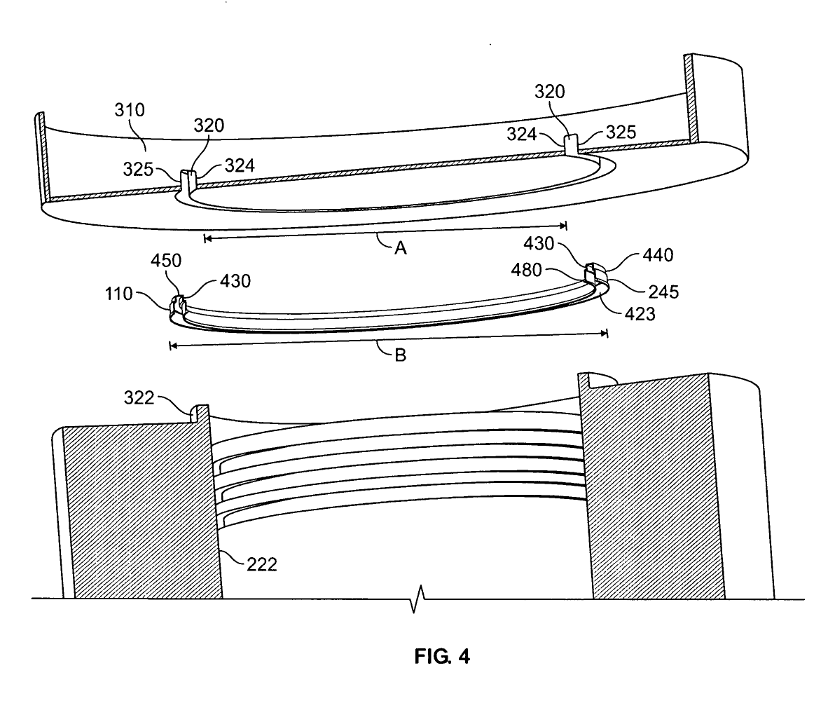

As shown in FIGS. 3 and 4, the fire ring 110 provides a seal between the cylinder head 220 and the engine block 230 around the cylinder bore 221. In a preferred embodiment, the cylinder 221 has a cylinder liner extension or protrusion 322 within the cylinder bore 221 that extends above the engine block 230. The protrusion 322 may extend about 3.6 mm above the engine block 230. The cylinder head 110 has an annular groove 320 that receives the protrusion 322 of the liner when the cylinder head 220 is placed on the engine block 230. The depth of the annular groove 320 may be about 4.0 mm into the cylinder head 220 with a width of about 4.0 mm. The fire ring 110 fits between the walls 324, 325 of the annular groove 320 and over the protrusion 322 of the cylinder wall liner 222 above the engine block 230.

As shown in FIG. 4, the fire ring 110 has a generally U-shape cross-section. The U-shape includes an opening 423 for the insertion of the cylinder wall protrusion 322 into the opening 423. The opening 423 is formed by two walls 430, 440. An inner diameter A of fire ring 110 defines the boundary of an innermost wall 430 of the fire ring 110 and an outer diameter B of the fire ring 110 defines the boundary of an outermost wall 440 of the fire ring 110 so that A is less than B. A base 450 having a defined length and other shape joins the walls 430, 440. Alternatively, the walls 430, 440 may be joined directly together without a base, such as for applications where the protrusion 322 and the annular groove 320 are peaked. Preferably, the fire ring 110 is made of metal or other material having formability, temperature resisting properties and spring-like resiliency. Further, the walls 430, 440 may have a draft angle about 1 degree or more.

Generally, the diameter of a cylinder bore 221 is dependent upon the size of the engine 200. Thus, the fire rings 110 may be configured for various sizes of combustion chamber cylinders 221 for different engines. In a typical engine, the thickness of the wall of the fire ring 110 may be about 0.25 mm. The thickness may be approximately uniform throughout the walls 430, 440 and the base 450 of the fire ring 110.

The fire ring 110 may be shaped to snugly fit over the surfaces of the protrusion 322 and within the walls of the annular groove 320. In one method of installation, the fire ring 110 is placed over the protrusion 322, and the combination of the protrusion 322 and fire ring 110 is inserted into the annular groove 320. With the fire ring 110 properly situated, the cylinder head 220 will then be brought into tight contact with the engine block 230 by tightening the bolts 260. As the bolts 260 are tightened, the fire ring 110 will be forced fully into the annular groove 320.

Alternatively, the fire ring 110 may be inserted into the annular groove 320 first. Then, the cylinder head 220 may be placed on the engine block 230 simultaneously aligning the protrusion 322 of the cylinder wall liner with the opening 423 of the fire ring 110. The protrusion 322 of the cylinder wall liner will be forced into the opening 423 of the fire ring 110 as the bolts 260 for the cylinder head 220 are tightened and the head is secured to the engine block 230. Further, the tightening of the bolts 260 may force the fire ring 110 further into the annular groove 320 in the cylinder head 220, forming a seal.

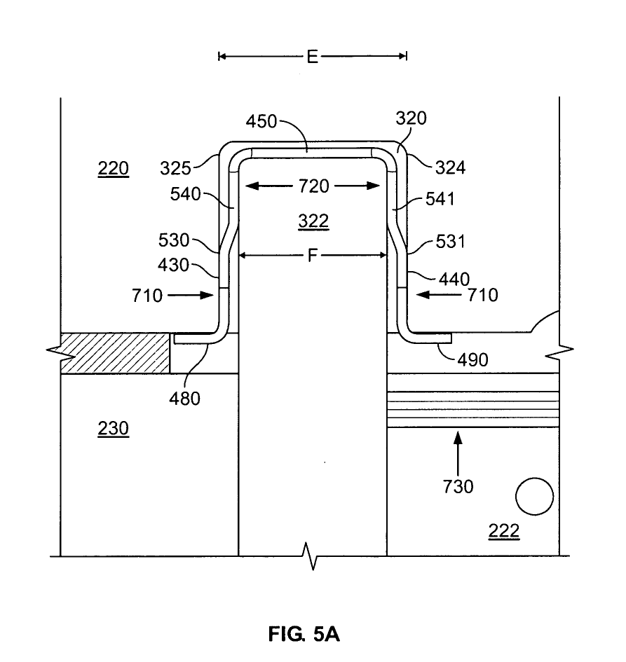

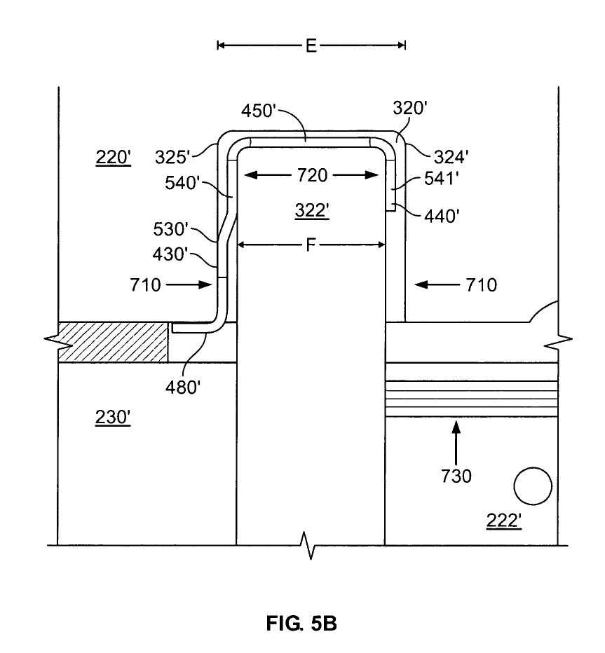

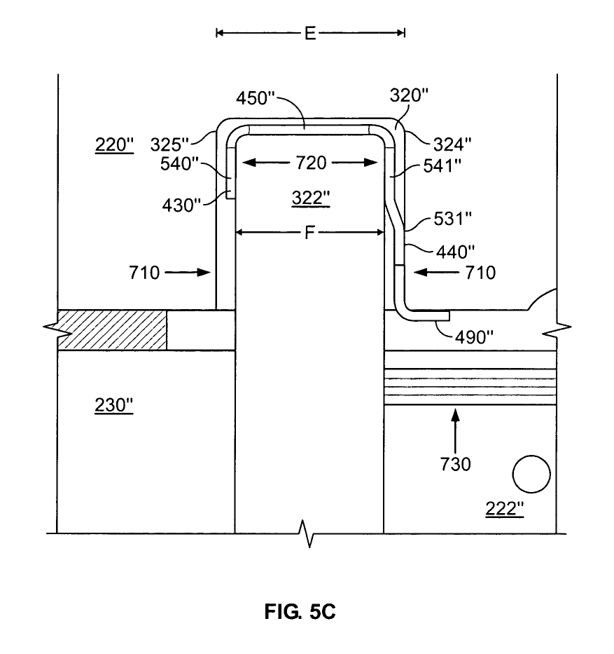

FIG. 5 illustrates how the seal with the fire ring 110 is formed. The fire ring 110 has stepped regions 530, 531 and non-stepped regions 540, 541 integrally formed in both of its walls 430, 440. The non-stepped regions 540, 541 are between the stepped regions 530, 531 and the base 450. The stepped regions 530, 531 are directly across from each other, making the distance E between the outer surfaces of opposing stepped regions 530, 531 equal to or greater than the length of the base 450 and greater than the distance F between the non-stepped regions 540, 541 of the walls 430, 440.

Alternatively, the stepped regions 530, 531 may occur adjacent to the base 450, making the length of the base 450 equal to the distance E between the outer surfaces of stepped regions 530, 531. The stepped regions 530, 531 would be between the non-stepped regions 540, 541 and the base 450.

When the fire ring 110 is inserted into the groove 320, the stepped region 530, 531 makes resilient contact and sealing engagement with the walls 325, 324 of the annular groove 320. The non-stepped regions 540, 541 fit snugly against and make a sealing engagement with the protrusion 322 of the cylinder wall liner when the protrusion 322 is inserted into the opening 423 (see FIG. 4) of the fire ring 110. The base length is chosen to conform to the thickness of the protrusion and the base 450 is shaped to conform to the cross-sectional shape of the protrusion.

As the combination of the fire ring 110 and protrusion 322 of the cylinder wall liner are inserted into the annular groove 320, the walls 324, 325 of the annular groove 320 press against the adjoining stepped regions 530, 531. The insertion of the fire ring 110 into the annular groove 320 slightly flexes the stepped regions 530, 531. The resilient nature of the fire ring material and the flexing of the stepped regions press the non-stepped regions 540, 541 against the protrusion 322. The resulting contact between the walls 324, 325 with the stepped regions 530, 531, and the contact between the non-stepped regions 540, 541 and the protrusion 322 provides multiple sealing engagements between the cylinder head 220 and the engine block 230.

FIG. 5B illustrates an alternative embodiment of the fire ring 110. As shown in FIG. 5B, a stepped region 530′ may be formed on only one wall 430′. The opposite wall 440′ lacks a stepped region and has only a non-stepped region 541′. A flange 480′ may be formed in the wall 430′ with the stepped region 530′. The non-stepped region 540′ in the wall 430′ is positioned between the stepped region 530′ and the base 450′.

As shown in FIG. 5B, the stepped region 530′ is in resilient contact with and seals against the wall 325′ of the annular groove 320′. The non-stepped region 540′ fits snugly against the protrusion 322′. When positioned in the annular groove 320′, the stepped region 530′ is biased outward and pressed inward, and the non-stepped region 540′ is forced against the protrusion 322′, forming a seal. Thus, two seals are formed. Contact between the stepped region 530′ and the wall 325′ of the annular groove 320′ forms a first seal, and contact between the protrusion 322′ and the non-stepped region 540′ forms a second seal. With the stepped region 530′ formed on the side of the protrusion 322′ remote from the cylinder bore 221′, the stepped region 530′ and the first and second seals are not directly exposed to the combustion gases.

In an alternative arrangement, the opposite wall 440′ and the base 450′ may be omitted. The non-stepped region 540′ fits snugly against the protrusion 322′ and the wall 325′ of the annular groove 320′ presses against the stepped region 530′. The resilient nature of the stepped region 530′ provides a force sufficient to press the non-stepped region 540′ against the protrusion 322′ forming a seal.

FIG. 5C illustrates a mirror image of the embodiment shown in FIG. 5B. The stepped region 531″ is formed on the wall 440″ closet to the cylinder bore 221″. The opposite wall 430″ has only a non-stepped region 540″. A flange 490″ may be formed on the wall 440″ with the stepped region 531″ to provide radial rigidity. The non-stepped region 541″ is positioned between the stepped region 531″ and the base 450″.

As shown in FIG. 5C, the stepped region 531″ makes resilient contact and seals against the wall 324″ of the annular groove 320″. The non-stepped region 541 ″ fits snugly against the protrusion 322″. Due to the resilient nature of the fire ring 110, the stepped region 531″ is pressed inward and the non-stepped region 541″ is forced against the protrusion 322″. As a result, two sealing regions are formed. The first sealing region occurs between the stepped region 531″ and the wall 324″ of the annular groove 320″, and the second sealing region is formed between the protrusion 322″ and the non-stepped region 541″.

As discussed previously, the opposite wall 430″ and the base 450″ may be omitted here as well. In this arrangement, the non-stepped region 541″ fits snugly against the protrusion 322″, and the wall 324″ of the annular groove 320″ presses against the stepped region 531″. A flange 490″ is formed in the wall 440″ to provide radial rigidity.

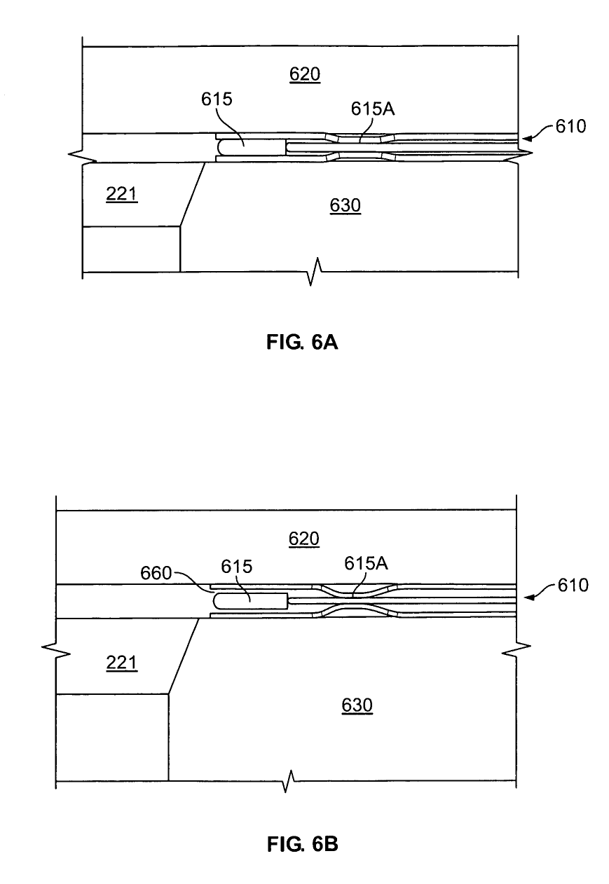

In a conventional engine, the force for sealing the head gasket is solely in a direction normal to the cylinder head and engine block mating surfaces, i.e., parallel to the tightening direction of the bolts 260. FIG. 6A illustrates a conventional head gasket 610 installed between a cylinder head 620 and an engine block 630. The head gasket 610 may have multiple layers. It may also include a conventional stopper component 615 and combustion seal 615A that surrounds the perimeter of cylinder bore 221 between the engine block 630 and cylinder head 620. In the absence of a compression and combustion cycle, a positive seal occurs between the head gasket 610, the stopper component 615, the combustion seal 615A, the cylinder head 620 and the engine block 630.

When compression and combustion pressures are encountered as in FIG. 6B, minute elastic deformations or micro-movements of the cylinder head 620, head gasket 610 and engine block 630 may occur. The pressures that cause these tiny movements provide further loading to the cylinder head 620 and the cylinder head bolts 260 in the normal direction. These micro-movements or deformations are in addition to any deformations encountered from forces that result from the tightening of the bolts 260 to secure the cylinder head 620 to the engine block 630. The resulting micro-movement is also known as combustion lift, where the cylinder head 620 can separate from the head gasket 610 and the engine block 630. An exaggeration of the separation 660 is shown in FIG. 6B. After the occurrence of many such micro-movement cycles, the continuous flexing of the head gasket 610 may cause fatigue and failure of the combustion seal 615A.

The fire ring 110 of the preferred embodiment is not affected in the same way by the compressive and combustion forces encountered by the conventional head gasket 610. FIG. 5 illustrates the forces that provide the sealing action of the fire ring 110. The sealing forces occur at locations 710, 720 and are perpendicular to the forces 730 that contribute to combustion lift. As compared with the conventional head gasket 610, the sealing pressure of the fire ring 110 is perpendicular to the compressive forces and is essentially uniform throughout the combustion cycle. The sealing pressure is not affected by any variations of the cylinder head deck thickness due to the incorporation of various ports and openings that accommodate the valves and oil draining passages. Other thickness variations may occur in the areas where the walls of the water jacket are thinner for maximum heat removal.

The contact sealing pressure created by the fire ring 110 is based on the concept of hoop stress. The fire ring 110 has a particular diameter and base length that is pre-determined in correspondence with the corresponding dimensions of the annular ring 320 into which it is inserted. The fire ring dimensions are selected to provide a hoop stress that maximizes the sealing forces. When the fire ring 110 is brought into contact with the walls 324, 325 of the annular groove 321 and the protrusion 322, the walls 430, 440 of the fire ring are subjected to radially directed tension and compression caused by the flexing or deformation forces between the protrusion 322 and head 220. An addition of flange portions 480, 490 to either or both of the walls 430, 440 of the fire ring 110 may provide rigidity to achieve a consistent contact pressure for sealing the fire ring 110 to the protrusion 322 and the walls 324, 325 of the annular groove 320 even after the fire ring 110 is installed. The flange portions 480, 490 are part of the fire ring 110 that remain outside of the annular groove 320. The flange portions 480,490 extend substantially parallel to the diameter of the fire ring 110, thus making the fire ring 110 stronger in the radial direction.

As discussed previously, the micro-motion from the combustion and compression cycles is directed to separate the cylinder head 220 from the engine block 230. The micro-motion has no direct effect on the seal between the fire ring 110 and the walls of the annular groove 320. In particular, the micro-motion will not separate the seal or break the physical contact between the walls of the protrusion 322 and the inner surface of the non-stepped regions 540, 541 of the fire ring 135 and the contact between the walls 324, 325 of the annular ring 320 and the stepped regions 530, 531. Thus, the fire ring 110 essentially avoids the multiple separations about the sealing surface that results from the repetitive lift and the resulting fatigue that eventually affects the conventional head gasket 610. Since fatigue failure associated with combustion lift should not be an issue for the fire ring 110, the fire ring 110 can be configured with a single layered steel gasket body instead of a conventional multi-layer steel gasket design as shown in FIGS. 6A and 6B.

As the head bolts 260 are tightened to secure a cylinder head 610 to an engine block 230 with a conventional head gasket arrangement, the load factor on the bolts 260 is high. The bolt load includes the required compression forces on the head gasket 610 to maintain a positive seal during engine operation. The compression of the fire ring 110 between the annular groove 320 and the protrusion of the cylinder liner 322 contributes very little to the bolt load other than the forces required to fit the fire ring 110 around the protrusion 322 of the cylinder wall liner and into the annular groove 320 of the cylinder head 220. The insertion force that is required to force the fire ring 110 into the annular groove 320 is released back to the bolts 260 once the fire ring 110 is fully inserted into the annular groove 320. The sealing force of the fire ring 110 is in the direction perpendicular to the bolt forces and is not affected by the separation of the cylinder head 220 from the engine block 230.

Advantages provided by embodiments of the fire ring 110 include minimum exposure of the fire ring 110 to combustive forces when the spark ignites the fuel/air mixture. The exposure gap for the fire ring 110 is equal to or less than about 0.5 mm. Since combustion lift is not a factor for the fire ring 110, the combustion does not permeate around the seal as it does around a conventional head gasket 610. Also, the fire ring 110 may provide multiple sealing points or surfaces between the walls 324, 325 of the annular groove 320 and the protrusion 322. This provides a very long leak path for the combustion gases, and air traps may occur between the multiple sealing surfaces of the walls 324, 325 and protrusion 322, providing for a better seal.

Another advantage of the fire ring 110 is that the cylinder liner 222 having the protrusion 322 portion may be inserted into a cylinder bore 221 of an aluminum engine block rather than casting the protrusion 322 as part of the engine block 230. For example, an aluminum engine block 230 may be cast without a cylinder liner 222. Once the block 230 is cast, the machining process of the engine block 230 will be accomplished. After machining, the cylinder liner 222 with the protrusion 322 is press fitted to the cylinder bore 221.

Installation of the fire ring 110 has no implications for displacement or a volume effect on the cylinder chamber volume. If an engine designer elects to change the compression ratio for a given engine, the adjustment may be made without changing the configuration of the head gasket 240 and more importantly of the fire ring 110.

Although a preferred embodiment has been described with the extension of the cylinder wall liner 222 interfacing with an annular groove 320 in the cylinder head 220, an embodiment may be provided where the extension is on the cylinder head and the annular groove may be provided in the engine block in close vicinity of the cylinder wall (not shown). The fire ring would then be inverted and would essentially work with the same principles as described above.

The fire ring seal 110 may be used in other applications or environments for sealing connections of piping that direct exhaust gases. The fire ring 110 may be used in various configurations such as those used for sealing an exhaust manifold (not shown) to the exhaust ports on a cylinder head 220. In many cases the ports may not be circular in shape and the seal will have to accommodate those shapes. Thus, the fire ring 110 may require geometrical shapes or patterns that provide a seal between the cylinder head 220 and the exhaust manifold using the general concepts shown in FIG. 1.

In a further embodiment, the fire ring 110 may be provided between an exhaust manifold and a header pipe (not shown) that receives the exhaust gases from the exhaust manifold. Referring once again to FIG. 1, the required protrusion element 130 that fits into the groove of the fire ring 110 may be provided on a mating surface of the cylinder head, the exhaust manifold or the header pipe with the groove 120 provided on the opposing surface.

One of the walls 430, 440 and the base 450 may be omitted from the fire ring 110 as was described previously. Such a fire ring 110 that lacks one wall 430, 440 and the base 450 may be used to seal slip joints that are commonly used for mating two sections of pipe together. The pipe sections are generally secured and held together by clamps and flanges that are readily known in the art. Such slip joints also may be implemented as mating surfaces between cylinder heads, exhaust manifolds and header pipes and the modified fire ring may be used to seal these slip joints.

It is to be understood that the embodiments described are not limited to the details of construction and the arrangement of components set forth in the following description or illustrated in the following drawings which are provided as examples. Embodiments can take other forms and may be used in other applications. The various features and advantages of the fire ring are set forth in the following claims.

What is claimed is:

1. A fire seal comprising:
a first wall;
a second wall spaced from the first wall;
a base connecting the first wall and the second wall, the base having a defined length, the base, the first wall and the second wall defining a generally U-shape cross-section; and
a stepped region in the first wall and a stepped region in the second wall such that a distance between the stepped regions of the first wall and the second wall is equal to or greater than the length of the base.

2. The fire seal of claim 1, wherein the fire seal fits within a groove in a cylinder head and includes an opening for receiving a protrusion from a cylinder wall liner in an engine block.

3. The fire seal of claim 2, wherein the protrusion is in sealing engagement with the non-stepped regions of the first wall and the second wall when the protrusion and fire seal are tightly inserted in the groove.

4. The fire seal of claim 2, wherein at least one of the stepped regions of the first wall and the second wall is in sealing engagement with at least one wall of the groove in the cylinder head when the protrusion and fire seal are tightly inserted in the groove.

5. The fire seal of claim 1, wherein the fire seal provides sealing engagement between a header pipe and an exhaust manifold.

6. The fire seal of claim 1, wherein the fire seal further comprises a flange on at least one of the first wall and the second wall.

7. The fire seal of claim 1, wherein the fire seal is integral to a head gasket.

8. The fire seal of claim 1, wherein the fire seal provides sealing engagement between a cylinder head gasket and an engine block.

9. The fire seal of claim 1, wherein the thickness of the first wall and the second wall are about the same.

10. A fire seal comprising a first wall and a second wall joined together, each wall having a stepped region and a non-stepped region such that the stepped region of the first wall is spaced a first distance from the stepped region of the second wall, and the non-stepped region of the first wall is spaced a second distance from the non-stepped region of the second wall.

11. The fire seal of claim 10, wherein the first distance is less than the second distance.

12. The fire seal of claim 10, wherein at least one of the non-stepped regions of the first wall and the second wall is adapted for sealing engagement with a protrusion of a cylinder wall liner in an internal combustion engine.

13. The fire seal of claim 10, wherein at least one of the stepped regions of the first wall and the second wall is adapted for sealing engagement with at least one wall of an annular groove in a cylinder head in a internal combustion engine.

14. The fire seal of claim 10, wherein the fire seal is integral to a head gasket.

15. The fire seal of claim 10, wherein the fire seal provides sealing engagement between an exhaust header pipe and an exhaust manifold.

16. The fire seal of claim 10, wherein the fire seal provides sealing engagement between a cylinder head and an engine block when installed in an internal combustion engine.

17. The fire seal of claim 10, further comprising a flange on at least one of the first wall and the second wall.

18. A fire seal comprising at least a first wall having a stepped region and a non-stepped region, the non-stepped region contacting a protrusion in sealing engagement, and the stepped region being sufficiently resilient to be in sealing engagement with a wall in a cavity that receives the fire seal.

19. The fire seal of claim 18, wherein the cavity is a groove in a cylinder head and the protrusion is a cylinder wall liner extending above an engine block, the cylinder head being secured to the engine block by a bolt.

20. The fire seal of claim 19, wherein the cylinder head is bolted to an engine block, and wherein the sealing engagement creates sealing pressure in a direction perpendicular to a direction of a force exerted by the bolt.

21. The fire seal of claim 18, wherein the fire seal provides a sealing engagement between an exhaust manifold and an exhaust header pipe.

22. The fire seal of claim 18, further comprising a second wall joined together with the first wall, the first wall and the second wall defining a cavity to receive the protrusion.
